(19) United States
(12) Patent Application Publication
(10) Pub. No.: US 2023/0137643 A1
(43) Pub. Date: May 4, 2023

(54) SHEARS WITH A MECHANICAL END STOP

(71) Applicant: INNOVATION FABRICATION COMMERCIALISATION INFACO, Cahuzac sur Vère (FR)

(72) Inventors: David GAUTIER, Gaillac (FR); David PRADEILLES, Montans (FR)

(21) Appl. No.: 17/905,237

(22) PCT Filed: Mar. 2, 2021
(86) PCT No.: PCT/EP2021/055121

§ 371 Date: Aug. 29, 2022

(30) Foreign Application Priority Data
Mar. 2, 2020 (FR) FR2002090

(51) Int. Cl. A01G 3/02; A01G 3/037

(52) U.S. Cl. CPC A01G 3/021; A01G 3/037

(57) ABSTRACT

Portable motorized electric shears include at least one mobile blade, an electric motor for driving the at least one mobile blade, and at least one mechanical end stop for the mechanical end of travel of the mobile blade in at least one direction of travel; a structure for detecting abutment against the stop, in the at least one direction of travel, on the basis of a current drawn by the electric motor.

The present invention relates to portable electric motorized shears with a mechanical end stop.

The field of the invention is the field of portable electric motorized shears.

### STATE OF THE ART

Portable electric motorized shears comprise a cutting tool having at least one movable blade and an electric motor for actuating said movable blade. The transition from manual shears to portable electric motorized shears has made it possible to increase the productivity of their operators while reducing the fatigue generated.

Nevertheless, motorized shears are not without their drawbacks. Thus they often tend to fall out of adjustment, which can alter the displacement travel of the movable blade. In extreme cases, this can even result in derailment of this movable blade.

In order to ensure that the movable blade is not displaced beyond the intended displacement travel, current shears are fitted with end-of-travel detection means. These means typically comprise one or more position sensors, for example (Hall-type) magnetic field sensors, associated with one or more magnets.

However, using such detection means increases the number of elements present in the shears and naturally increases their bulk, complexity and cost. In addition, these detection means need to be correctly positioned and calibrated, thus increasing the complexity of assembling the shears. Moreover, these detection means generally tend to fall out of adjustment, thus increasing the necessity for maintenance of the tools.

An aim of the present invention is to overcome at least one of the aforementioned drawbacks.

Another aim of the present invention is to propose shears in which the movable blade end-of-travel is detected in a simpler, more cost-effective, less bulky and more reliable manner.

### DISCLOSURE OF THE INVENTION

The invention makes it possible to achieve at least one of these aims with portable electric motorized shears comprising at least one movable blade, an electric motor for driving said at least one movable blade, and at least one mechanical end-of travel mechanical end stop of said movable blade in at least one direction of displacement, characterized in that it also comprises an end stop detection means, in said at least one direction of displacement, as a function of a current consumed by said electric motor.

It is thus proposed that the shears according to the invention detect the end stop position of the movable blade as a function of the current consumed by the motor of the shears. Indeed, when the movable blade reaches the mechanical end stop position, this results in an increase in the current consumed by the electric motor. By monitoring the value of this current, it is therefore possible to detect abutment of the blade. Consequently, it is not necessary to use a dedicated sensor, of the magnetic sensor, magnet or Hall-effect sensor type, monitoring the position of the movable blade.

Thus, the architecture of the shears is simplified, more cost-effective and less bulky.

Moreover, monitoring the position of the movable blade does not depend on the operation of a dedicated sensor, but only on the presence of a mechanical end stop and the motor current, which is more robust.

In addition, the reduction in the number of electronic components required in the shears, in particular with respect to the movable parts, makes it possible for example to use a single electronic circuit board in the shears. This also makes it possible to avoid the use of connecting wires between several electric circuit boards and thus to improve the reliability of the shears. Indeed, such wires can constitute an increased failure risk, in particular by breaking at their point of contact with the electronic circuit boards.

The shears according to the invention can comprise a cutting tool fitted with a single movable blade associated with a fixed counter-blade or, alternatively, a cutting tool comprising two movable blades.

The electric motor of the shears can be for example of the brushless type.

The motor can drive at least one blade, generally in rotation, in a direction corresponding to the closing direction of the cutting tool and in the reverse direction corresponding to the opening direction of the cutting tool.

According to an embodiment, at least one mechanical end stop can be placed on any element of the shears.

This mechanical end stop can be placed for example on the body of the shears, or on a fixed counter-blade, so that the movable blade comes into contact with said mechanical end stop at end-of-travel.

Advantageously, at least one mechanical end stop can be provided on said at least one movable blade.

Thus, it is possible to fit the shears with a mechanical end stop without the need to interfere with the architecture of the shears, but only with the movable blade. Consequently, it is possible to fit each movable blade with a mechanical end stop adapted to the movable blade, during manufacture of the blade.

According to an embodiment, at least one mechanical end stop can comprise a shape that projects from the movable blade, such as a tear drop or bump, and is provided to abut against a portion of the body of the shears or of the counter-blade.

According to an embodiment, at least one movable blade can comprise a toothed section engaging with a toothed wheel, at least one mechanical end stop being formed by a modification of the toothing profile of said toothed section, at at least one of its ends.

Thus, it is possible to fit a movable blade with at least one mechanical end stop directly during its manufacture. In addition, it is not required to add any additional element to the movable blade in order to fit it with a mechanical end stop.

The modification of the toothing profile can preferably be carried out at the level of the last tooth, or even the penultimate tooth, located near one end of the toothed section of the movable blade.

Preferably, non-limitatively, at least one mechanical end stop can be formed by a gullet the depth of which is reduced compared with the other gullets of the toothed section. Alternatively, any other modification of the toothing profile can be suitable to form a mechanical end stop. For example, it is possible to modify the thickness of a tooth, its height or even to reduce the gap between two teeth.

According to an embodiment, the shears can comprise several mechanical end stops.

Thus, it is possible to detect different displacement ends-of-travel in the shears according to the invention, and to correspondingly reduce the additional sensors that it would have been necessary to use in the solutions of the state of the art.

When the shears comprise a movable blade cooperating with a fixed counter-blade, then the shears according to the invention can comprise several, in particular two, mechanical end stops for said movable blade. In this case, each mechanical end stop can constitute a mechanical end-of-travel limit of said movable blade in a direction of displacement of the movable blade.

When the shears comprise two movable blades cooperating with one another, then the shears according to the invention can comprise at least one mechanical end stop, and in particular two mechanical end stops, for each movable blade. Each mechanical end stop associated with each movable blade can constitute a mechanical end-of-travel limit in a direction of displacement of said movable blade.

According to an embodiment, the end stop detection means can be configured to compare the current consumed by the motor with a predefined threshold.

Thus, it is possible to associate a value of current consumed by the electric motor corresponding to an abutment of the movable blade against the mechanical end stop. It is also possible to adjust this current value upwards, or downwards. This makes it possible to prevent every increase in the motor current, in particular during a cut, from erroneously triggering detection of a mechanical end stop.

Advantageously, the shears according to the invention can comprise at least one theoretical end-of-travel end stop of at least one movable blade, the position of which is defined as a function of at least one mechanical end stop and:
of a number of motor revolutions or
of a duration of drive.

In this case, the end stop detection means can be configured to detect at least one theoretical end stop in at least one direction of displacement of at least one movable blade.

Thus, it is possible to define a theoretical displacement end-of-travel of at least one movable blade that is different from the mechanical end-of-travel.

Consequently, it is possible to have a theoretical end-of-travel end stop close to the mechanical end-of-travel. This makes it possible to limit the displacement travel of the blade without the need for mechanical abutment, which makes it possible to limit the excess consumption linked to mechanical abutment. This also makes it possible to limit the wear of elements of the shears, in particular the motor and the mechanical end stop.

In particular, for a given direction of displacement of a movable blade, at least one theoretical end stop can be defined on the same side as the mechanical end stop.

Alternatively or in addition, for a given direction of displacement of a movable blade, at least one theoretical end stop can be defined on the opposite side from a mechanical end stop. Thus, it is possible to have a theoretical end stop to limit the displacement of the blade in the opposite direction to the mechanical end stop. This makes it possible to restrict the displacement of the blade in both its directions of displacement.

The detection means can comprise a single unit configured to detect both the at least one mechanical end stop and the at least one theoretical end stop.

Alternatively, the end stop detection means can comprise a first unit for detecting at least one mechanical end stop and a second unit, distinct from said first unit, for detecting at least one theoretical end stop.

According to an embodiment, the position of one or every theoretical end stop can be recorded in the shears at the factory.

According to an embodiment, the shears according to the invention can comprise an input means for defining the position of at least one theoretical end stop.

Thus, it is possible to define and modify the position of a theoretical end stop and therefore to customize one or every theoretical end stop. For example, it is possible to increase the possible displacement travel of the blade, in particular to compensate for wear of the latter. It is also possible to reduce the displacement travel of the blade, for example to optimize the consumption of the shears during small cuts.

According to an embodiment example, the input means can comprise a communication interface making it possible to define the position of at least one theoretical end stop digitally, as a number of motor revolutions, or as a drive duration, for example in the form of digital instructions transmitted by an external apparatus of the computer type and stored in the shears.

Alternatively, or in addition, the theoretical end stop input means can comprise a manual input means for defining the position of at least one theoretical end stop.

This manual input means can for example comprise a user interface or a button, in particular a control knob, making it possible to enter the position of a theoretical end stop.

According to an embodiment example, this manual input means can be provided to enter a number of motor revolutions, or a drive duration, corresponding to the position of a theoretical end stop starting from a mechanical end stop, for example via a user interface including a keypad, a control knob, etc.

Alternatively or in addition, the manual input means can be provided to enter the current position of the movable blade as theoretical end stop position. In this case, the blade is displaced to the desired position, and once this position is reached it is entered as theoretical end stop position, for example by pressing on a save button.

According to an embodiment of the invention, the shears can be programmed to implement an initialization sequence comprising a mechanical abutment of at least one movable blade.

A mechanical abutment consists of driving the blade in a direction of displacement until it is in the mechanical end stop position.

This makes it possible to ensure correct positioning of the blade of the shears according to the invention and correct detection of the theoretical end stop positions, as appropriate.

This initialization sequence can for example be performed each time the shears are powered up. Alternatively, this initialization can be performed at regular intervals, for example defined as the number of cuts carried out or time passed since the last initialization.

According to an embodiment, the shears according to the invention can comprise several theoretical end stops.

Thus, it is possible to detect different theoretical displacement ends-of-travel in the shears according to the invention, without the need for mechanical abutment.

When the shears comprise a movable blade cooperating with a fixed counter-blade, then the shears according to the invention can comprise several, in particular two, theoretical end stops for said movable blade. In this case, each theoretical end stop can constitute a theoretical end-of-travel limit in a direction of displacement of the movable blade.

When the shears comprise two movable blades cooperating with one another, then the shears according to the invention can comprise at least one theoretical end stop, and in particular two theoretical end stops, for each movable blade. Each theoretical end stop associated with each movable blade can constitute a theoretical end-of-travel limit in a direction of displacement of said movable blade.

According to a particular embodiment, the shears according to the invention can comprise a movable blade associated with a fixed counter-blade.

In this embodiment, the shears according to the invention may comprise two mechanical end stops for the movable blade, each defining a mechanical end-of-travel in a direction of displacement of said movable blade.

Thus, it is possible to mechanically restrict the displacement of the movable blade in each of its two directions of displacement, without using additional sensors. This thus makes it possible to avoid any misalignment of the movable blade during its displacement.

Still in this embodiment, the shears according to the invention may be programmed to implement an initialization sequence comprising:
a first mechanical abutment of the movable blade with a first mechanical end stop, in one direction of displacement,
a second mechanical abutment of the movable blade with a second mechanical end stop, in the opposite direction of displacement, and
determining a fitted blade kit as a function of a number of motor revolutions, or of a duration of drive, between said mechanical end stops.

Thus, the movable blade is first driven in a first direction of displacement, preferably the opening direction of the tool, until it is in the mechanical end stop position with a first mechanical end stop. The movable blade is then driven in the reverse direction, until it is in the mechanical end stop position with the other mechanical end stop.

In the knowledge of the required number of motor revolutions, or the required drive duration, for displacing the movable blade from one mechanical end stop position to the other, it is possible to determine what type of blade, or blade kit, is mounted on the shears. In fact, the different blade kits capable of being mounted on the shears are designed to carry out cuts of different sizes, and therefore to open by different amounts. Thus, each blade kit has dimensions specific to it, making it possible to open the blades by different amounts. Thus, the required number of motor revolutions, or the required drive duration, for displacing the movable blade from one mechanical end stop to the other is specific to each blade kit.

Consequently, it is possible for the shears to identify each blade kit as a function of the required number of motor revolutions, or the required drive duration, for displacing the fitted movable blade from one mechanical end stop to the other.

The characteristics making it possible to determine each of the blade kits, defined as motor revolutions, or as drive duration, are preferably recorded in the shears at the factory.

Also in this embodiment, the shears can comprise two theoretical end stops for the movable blade, each defining a theoretical end-of-travel in at least one direction of displacement of said movable blade.

Thus, it is possible to restrict the displacement of the single movable blade between two theoretical end stops. Consequently, it is possible to restrict the travel of the movable blade in both directions of displacement of the movable blade, without the need for mechanical abutment.

According to a variant of this embodiment, the position of one or each of the two theoretical end stops can vary as a function of the blade kit fitted on the shears. The positions of these theoretical end stops, specific to each of the blade kits, may preferably be recorded in the shears, for example at the factory.

### DESCRIPTION OF THE FIGURES AND EMBODIMENTS

Other advantages and characteristics will become apparent on examination of the detailed description of an embodiment that is in no way limitative, and of the attached drawings, in which

FIGS. 1a and 1b are partial diagrammatic representations of a non-limitative embodiment example of shears according to the invention;

FIGS. 2a and 2b are partial diagrammatic representations of another non-limitative embodiment example of shears according to the invention;

FIGS. 3a and 3b are partial diagrammatic representations of yet another non-limitative embodiment example of shears according to the invention;

FIG. 4 is a partial diagrammatic representation of another non-limitative embodiment example of shears according to the invention; and

FIG. 5 is a partial diagrammatic representation of another non-limitative embodiment example of shears according to the invention.

It is well understood that the embodiments that will be described hereinafter are in no way limitative. In particular, variants of the invention may be envisaged comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In the figures, elements common to several figures retain the same reference.

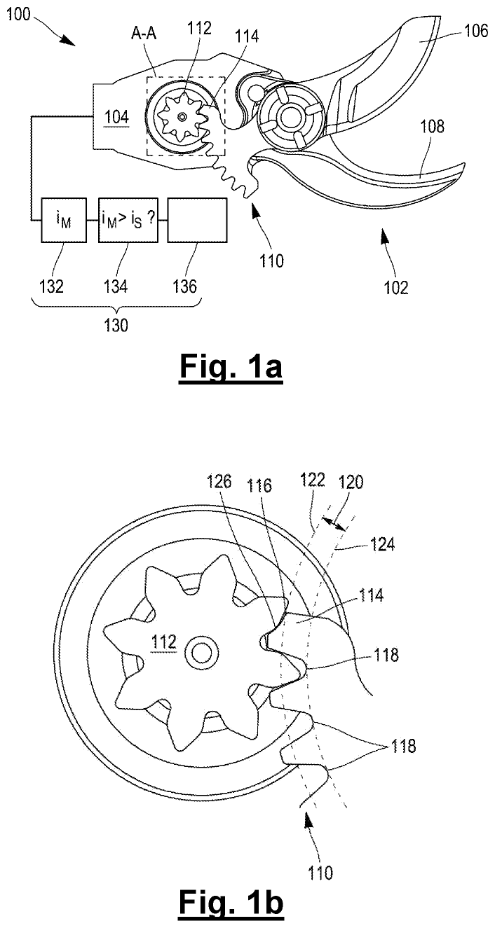

FIGS. 1a and 1b are partial diagrammatic representations of a non-limitative example of shears according to the invention.

In particular, FIG. 1a shows a distal part of portable electric motorized shears 100. FIG. 1b shows, in an enlarged view, elements comprised within the box A-A in FIG. 1a.

The portable electric motorized shears 100 are fitted with a cutting tool 102 mounted on a distal end of the body 104 of the shears. The cutting tool 102 comprises a movable blade 106 associated with a fixed counter-blade 108.

The movable blade 106 comprises, at its end located on the side of the body 104 of the shears, a toothed section 110 engaged with a toothed wheel 112 placed on the body 104 of the shears. An electric motor (not shown) is provided to drive the toothed wheel 112 in both directions of rotation so as to drive the movable blade 106, in rotation, in both directions of drive, namely in the opening direction or in the closing direction of the movable blade.

The shears 100 comprise a mechanical end stop 114, provided on the movable blade 106. This mechanical end stop 114 is provided at one end of the toothed section 110 of the movable blade 106.

The movable blade 106 as shown in FIGS. 1a and 1b is in a mechanical end stop position, the mechanical end stop 114 being in contact with the toothed wheel 112. The mechanical end stop position of the movable blade 106 shown corresponds to the mechanical end-of-travel position of said movable blade 106 in the opening direction of the cutting tool. Thus, when the movable blade 106 is in mechanical abutment, it can no longer continue to open, because the mechanical end stop 114 physically prevents its rotation in the opening direction and therefore its opening beyond said mechanical end stop 114.

As shown in greater detail in FIG. 1b, in the shears 100, the mechanical end stop 114 is formed by a modification of the toothing profile of the toothed section 110. In particular, the mechanical end stop 114 is formed by a gullet 116 the depth of which is reduced compared with the depth of the other gullets 118 of the toothed section 110. In other words, the gullet 116 is higher than the other gullets of the toothed section. The height difference 120 between the gullet 116 forming the mechanical end stop 114 and the other gullets 118 is indicated by their respective root circles 122 and 124. The modified toothing profile forming the mechanical end stop 114 comprises a flank 126 the shape of which is provided to receive, at least partially, the tooth flank of the toothed wheel 112.

In the example shown, it is the last gullet of the toothed section 110 that forms the mechanical end stop 114. Alternatively, another gullet of the toothed section 110 can be used as mechanical end stop, such as for example the penultimate gullet of the toothed section in the opening direction.

The shears 100 also comprise a mechanical end stop detection means 130. This mechanical end stop detection means 130 is tasked with monitoring the current i_{M} consumed by the electric motor for actuating the movable blade 106, in order to detect the moment at which the current consumed by the motor becomes greater than a predetermined threshold i_{S}. Indeed, when the movable blade 106 is in mechanical abutment, this prevents the blade opening further, so that the motor consumes more current in an attempt to continue to displace it in the opening direction. This increase in the current consumed by the motor therefore directly indicates that the movable blade 106 is in mechanical abutment, in the opening direction.

In the example shown, the mechanical end stop detection means 130 comprises:
a first module 132 measuring the current i_{M} consumed by the electric motor, in real time, or at least at a sufficiently high frequency with respect to the speed of displacement of the movable blade 106;
a second module 134 for comparing the value of the current i_{M} measured by the first module 132 with the threshold i_{S}; and
a third, optional, module 136, making it possible to trigger cessation of the drive of the movable blade 106 by the motor, followed or not by a driving of the movable blade 106 in the reverse direction.

Each of the modules 132, 134 and 136 can be produced with at least one digital component or at least one analogue component, or with any combination of digital component(s) and analogue component(s).

Each of the modules 132-136 can be independent. Alternatively, at least two of the modules 132-136 can be combined. For example, the modules 132-136 can be integrated in a single electronic component, such as an electronic chip for example.

Each of the modules 132-136 can be placed on an existing circuit board in the shears providing another function, or on a dedicated circuit board.

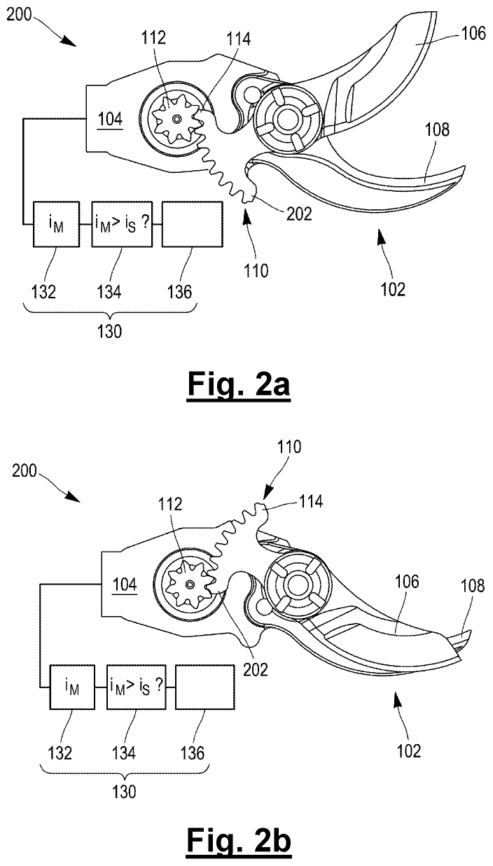

FIGS. 2a and 2b are partial diagrammatic representations of another non-limitative example of shears according to the invention.

The shears 200 in FIGS. 2a and 2b, shown in FIGS. 2a and 2b, comprise all the elements of the shears 100 in FIGS. 1a and 1b.

In addition, the portable electric motorized shears 200 include a second mechanical end stop 202 provided on the movable blade 106, and acting as mechanical end stop for the movable blade 106 in the closing direction of the movable blade 106.

Each mechanical end stop 114 and 202 is placed at one end of the toothed section 110 of the movable blade 106. Each mechanical end stop 114 and 202 thus constitutes a mechanical end-of-travel limit in a direction of displacement of the movable blade.

In FIG. 2a, the movable blade 106 is at the mechanical end-of-travel in the opening direction of the cutting tool 102. In this first mechanical end stop position, the mechanical end stop 114 is in contact with the toothed wheel 112.

In FIG. 2b, the movable blade 106 is at the mechanical end-of-travel in the closing direction of the cutting tool 102. In this second mechanical end stop position, the mechanical end stop 202 is in contact with the toothed wheel 112.

The second mechanical end stop 202 has an architecture similar to that of the end stop 114. In particular, as for the end stop 114, the mechanical end stop 202 is formed by a modification of the toothing profile of the toothed section 110. More particularly, the mechanical end stop 202 is formed by a gullet the depth of which is reduced compared with the depth of the other gullets 118 of the toothed section 110.

In the example shown, each mechanical end stop 114 and 202 is formed by the last gullet of the toothed section 110 at each of the ends of the toothed section 110. Alternatively, at least one of the mechanical end stops 114 and 202 can be formed by another gullet of the toothed section.

In the shears 200, the mechanical end stop detection means 130 of the shears 200 is configured to detect the mechanical abutment in both directions of drive of the movable blade 106. Indeed, during a mechanical abutment, regardless of the direction of displacement of the movable blade 106, a mechanical end stop 114, 202 prevents the displacement of the movable blade 106 when the latter comes into a mechanical end stop position, so that the motor consumes more current in an attempt to continue to displace it. This increase can thus be detected by the mechanical end stop detection means 130.

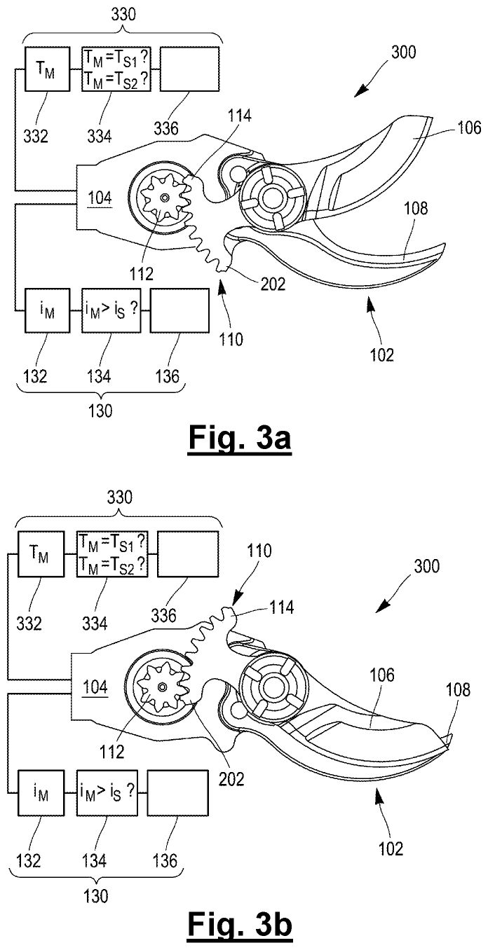

FIGS. 3a and 3b are partial diagrammatic representations of yet another non-limitative embodiment example of shears according to the invention.

The portable electric motorized shears 300 shown in FIGS. 3a and 3b comprise all the elements of the shears 200 shown in FIGS. 2a and 2b.

The shears 300 also comprise a theoretical end stop detection means 330.

Indeed, the shears 300 can be provided with one or two theoretical end stops. In the example shown, the shears 300 are provided with two theoretical end stops.

Each theoretical end stop has the function of restricting the travel of the movable blade 106, in at least one of its directions of displacement. Unlike a mechanical end stop 114 or 202, a theoretical end stop does not physically prevent the rotation of the blade 106. However, a theoretical end stop, and in particular its detection, makes it possible to stop the drive of the movable blade 106 by the motor, without the movable blade being in a mechanical end stop position.

In the example shown, the position of each theoretical end stop is defined as a function of a single mechanical end stop 114 or 202 and of a number of motor revolutions T_{M} required for the motor to displace the movable blade 106 from the position of said mechanical end stop to the position of said theoretical end stop.

In this example, the positions in motor revolutions T_{S1} and T_{S2} of the two theoretical end stops are pre-recorded in the shears 300, for example with respect to the position of the mechanical end stop 114. In FIG. 3a, the movable blade 106 is at theoretical end-of-travel, and therefore in a theoretical end stop position, in the opening direction of the cutting tool 102. This first theoretical end stop position is situated just before the mechanical end stop position 114 in the displacement travel of the movable blade 106 in the opening direction of the cutting tool 102. It will be noted that in the theoretical end-of-travel position in the opening direction as shown in FIG. 3a, the cutting tool 102 is slightly less open than in the mechanical end-of-travel position in the opening direction as shown in FIG. 2a. In FIG. 3b, the movable blade 106 is at theoretical end-of-travel, and therefore in a theoretical end stop position, in the closing direction of the cutting tool 102. This second theoretical end stop position is situated before the mechanical end stop position 202 in the displacement travel of the movable blade 106 in the closing direction of the cutting tool 202. It will be noted that in the theoretical end-of-travel position in the closing direction as shown in FIG. 3b, the cutting tool 102 is slightly less closed than in the mechanical end-of-travel position in the closing direction as shown in FIG. 2b.

In the example shown, the theoretical end stop detection means 330 comprises:
a first module 332 provided to keep and update a current motor revolution number T_{M}, also called register of the position of the movable blade, corresponding to the current position of the movable blade from a mechanical end stop position of the movable blade, preferably from the mechanical end stop position 114 in the opening direction of the cutting tool 102. In order to maintain this register, a first direction of rotation of the motor is assigned as positive and the reverse direction of rotation is assigned as negative, and at the mechanical end stop position T_{M}=0. For example, the direction of rotation driving the blade in the closing direction of the cutting tool is assigned as positive, so that T_{M} increases as the movable blade 106 closes, and the opening direction of the cutting tool is assigned as negative, so that T_{M} reduces as the movable blade 106 closes;
a second module 334 for comparing the value of the number of motor revolutions T_{M} in the register kept by the first module 332 with the positions T_{S1} and T_{S2} of the theoretical end stops expressed in motor revolutions; and
a third module 336, making it possible to trigger cessation of the drive of the movable blade 106 by the motor, followed or not by a driving of the movable blade 106 in the reverse direction, when the number of revolutions T_{M} is equal:
   to T_{S1}: this means that the movable blade has reached a theoretical end stop, for example a theoretical end stop in the opening direction;
   to T_{S2}: this means that the movable blade has reached the other theoretical end stop, for example the theoretical end stop in the closing direction of the blade.

Each of the modules 332, 334 and 336 can be produced with at least one digital component or at least one analogue component, or with any combination of digital component(s) and analogue component(s).

Each of the modules 332-336 can be independent. Alternatively at least two of the modules 332-336 can be combined. For example, the modules 332-336 can be integrated in a single electronic component, such as an electronic chip.

Each of the modules 332-336 can be placed on an existing circuit board in the shears providing other functions, or on a dedicated circuit board.

According to a variant that is not shown, the position of each theoretical end stop is defined as a function of a single mechanical end stop and of a duration of drive required for the motor to displace the movable blade at constant speed from the position of said mechanical end stop to the position of said theoretical end stop. The operation of the theoretical end stop detection means of this variant is similar to the operation of the theoretical end stop detection means described above with respect to FIGS. 3a and 3b.

According to another variant that is not shown, the positions of a first and a second theoretical end stop are defined as a function of a first and a second mechanical end stop and of a number of motor revolutions, or of a duration of drive. The operation of the theoretical end stop detection means of this variant differs from the operation of the theoretical end stop detection means described above with respect to FIGS. 3a and 3b in that two different blade position registers are kept by the first module, and in that the second module compares the values of the positions of each theoretical end stop with the current value in the corresponding register.

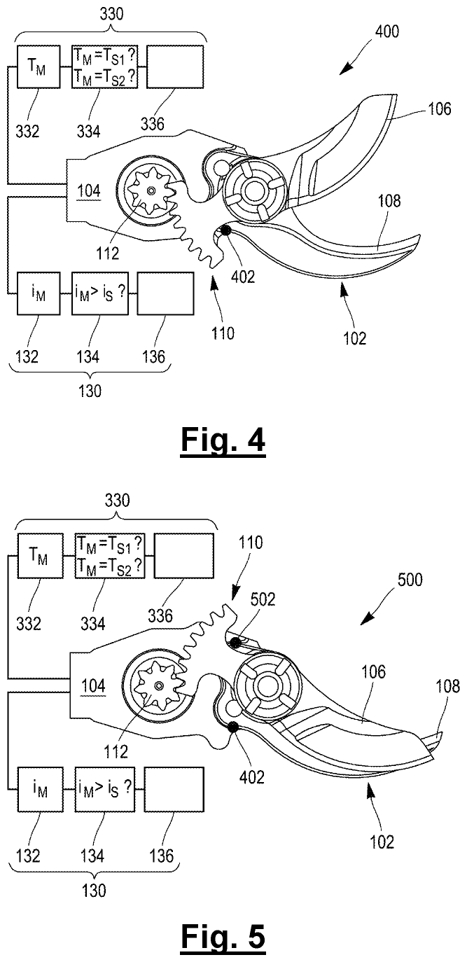

FIG. 4 is a partial diagrammatic representation of another non-limitative example of shears according to the invention.

The portable electric motorized shears 400 in FIG. 4 differ from the shears 300 in FIGS. 3a and 3b, in that they comprise a single mechanical end stop 402.

In addition, unlike the shears 300, the mechanical end stop 402 of the shears 400 is not formed on the movable blade but on the body of the shears 400. In particular, the mechanical end stop 402 is formed by a tear drop, and in general terms any shape, projecting from the body 104 of the shears, fixed and integral with said body 104 of the shears 400, against which the movable blade 106 comes into abutment when it is opening.

The movable blade 106 as shown in FIG. 4 is in a mechanical end stop position. In this position, the mechanical end stop 402 is in contact with a part of the blade comprised between the axis of rotation of the blade and its toothed section 110.

Apart from the mechanical end stop 402, the shears 400 comprise two theoretical end stops capable of being detected by the theoretical end stop detection means 330, like the shears 300. These theoretical end stops are defined as a number of motor revolutions, with respect to the position of mechanical abutment of the blade 106 with the mechanical end stop 402. These two theoretical end stops thus make it possible to restrict the displacement travel of the movable blade 406 in the direction of opening and of closing of the cutting tool 102.

According to an embodiment variant that is not shown, the shears 400 can comprise a single theoretical end stop defined with respect to the mechanical end stop 402, so as to form a theoretical displacement limit of the movable blade 106 in the closing direction of the cutting tool 102.

According to another variant that is not shown, the mechanical end stop 402 can be placed so as to physically restrict the displacement of the movable blade 106 in the closing direction of the cutting tool 102.

FIG. 5 is a partial diagrammatic representation of another non-limitative example of shears according to the invention.

The portable electric motorized shears 500 in FIG. 5 comprise all the elements of the shears 400 in FIG. 4.

The shears 500 also comprise a second mechanical end stop 502.

In the example shown, and non-limitatively, the second mechanical end stop 502 is in the form of a tear drop projecting from the body 104.

This mechanical end stop 502 physically restricts the displacement of the movable blade 106 in the closing direction of the cutting tool 102.

The movable blade 106 as shown in FIG. 5 is in a mechanical end stop position with the end stop 502.

The shears 500 as shown in FIG. 5 comprise two theoretical end stops.

According to an alternative that is not shown, the shears 500 can comprise a single theoretical end stop.

According to other variants that are not shown, it is possible for the shears 300, 400 and 500 in FIGS. 3a-3b, 4 and 5 not to have a theoretical end stop.

Of course, the invention is not limited to the examples detailed above.

1. A portable electric motorized shears comprising:
at least one movable blade;
an electric motor for driving said at least one movable blade; and
at least one mechanical end-of-travel end stop of said movable blade in at least one direction of displacement; and
an end stop detection means in said at least one direction of displacement, as a function of a current consumed by said electric motor.

2. The shears according to claim 1, characterized in that at least one mechanical end stop is provided on said at least one movable blade.

3. The shears according to claim 2, characterized in that said at least one movable blade comprises a toothed section engaging with a toothed wheel, at least one mechanical end stop being formed by a modification of the toothing profile of said toothed section, at at least one of its ends.

4. The shears according to claim 1, characterized in that the shears comprise several mechanical end stops.

5. The shears according to claim 1, characterized in that the end stop detection means is configured to compare the current consumed by the motor with a predefined threshold.

6. The shears according to claim 1, characterized in that they comprise at least one theoretical end-of-travel end stop of at least one movable blade, the position of which is defined as a function of at least one mechanical end stop and:
of a number of motor revolutions or
of a duration of drive;
the end stop detection means also being configured to detect at least one theoretical end stop in at least one direction of displacement of at least one movable blade.

7. The shears according to claim 6, characterized in that they comprise an input means for defining the position of at least one theoretical end stop.

8. The shears according to claim 6, characterized in that they comprise a manual input means for defining the position of at least one theoretical end stop.

9. The shears according to claim 1, characterized in that they are programmed to implement an initialization sequence comprising a mechanical abutment of at least one movable blade.

10. The shears according to claim 1, characterized in that the shears comprise several theoretical end stops.

11. Shears according to claim 1, characterized in that they comprise a movable blade associated with a fixed counter-blade.

12. The shears according to claim 1, characterized in that they comprise two mechanical end stops for the movable blade, each defining a mechanical end-of-travel in a direction of displacement of said movable blade.

13. The shears according to claim 9, characterized in that the initialization sequence comprises:
a first mechanical abutment of the movable blade with a first mechanical end stop, in one direction of displacement,
a second mechanical abutment of the movable blade with a second mechanical end stop, in the opposite direction of displacement, and
determining a fitted blade kit as a function of a number of motor revolutions, or of a duration of drive, between said mechanical end stops.

14. The shears according to claim 6, characterized in that they comprise two theoretical end stops for the movable blade, each defining a theoretical end-of-travel in at least one direction of displacement of said movable blade.
